(19) United States
(12) Patent Application Publication
(10) Pub. No.: US 2009/0282902 A1
(43) Pub. Date: Nov. 19, 2009

(54) BIO SURFACE ACOUSTIC WAVE (SAW) RESONATOR AMPLIFICATION FOR DETECTION OF A TARGET ANALYTE

(76) Inventor: Peter Warthoe, Copenhagen (DK)

Correspondence Address: THE NATH LAW GROUP, 112 South West Street, Alexandria, VA, 22314, US

(21) Appl. No.: 12/310,161

(22) PCT Filed: Aug. 17, 2007
(86) PCT No.: PCT/DK2007/000378

§ 371 Date: Feb. 13, 2009

(30) Foreign Application Priority Data
Aug. 17, 2006 (DK) PA 2006 01073

(51) Int. Cl. G01N 29/02

(52) U.S. Cl. 73/64.53

(57) ABSTRACT

The present invention relates generally to a signal amplification method for a SAW resonator microsensor for analyzing test samples, containing target analyte including proteins and nucleic acids. The invention relates to at least one surface acoustic wave resonator unit comprising a plurality of three-dimensional interdigital transducer electrode (IDTE) and reflector micro channels located on a piezoelectric substrate surface. The invention further relates to a change of solid/liquid volume ratio in said three-dimensional micro channels; said changes of the liquid/solid volume ratio can be directed correlated to the target analyte concentration in a test sample.

### TECHNICAL FIELD

The present invention relates generally to a SAW resonator unit and to a microsensor comprising said unit, which is useful for analyzing test samples.

The invention further relates to a surface acoustic wave resonator unit comprising a plurality of three-dimensional interdigital transducer electrode (IDTE) and reflector channels located on a piezoelectric substrate surface.

The invention further relates to a change of solid/liquid volume ratio in said three-dimensional micro channels; said changes of the liquid/solid volume ratio can be directed correlated to the target analyte concentration in a test sample. The microsensors find application in numerous chemical, environmental and medical applications.

### BACKGROUND

Sensitive detection of analyte, such as biological analyte, continues to be a significant challenge in analytical detection methods. Frequently, detection methods require processing of multiple samples. In addition, analytical detection methods should be easy, rapid and reproducible. This is particularly important, when highly specialized methods and reagents, such as diagnostic methods, are unavailable.

Conventional bioanalytical methods in particular have several deficiencies. For example, hybridization of nucleic acid molecules is generally detected by autoradiography or phosphor image analysis, when the hybridization probe contains a radioactive label, or by densitometer, when the hybridization probe contains a label, such as biotin or digoxin. The label can in turn be recognized by an enzyme-coupled antibody or ligand. Most modern biomolecule detection methods require modification of the molecule, e.g. DNA or RNA or protein, making current detection methods expensive and labor intensive.

Acoustic wave sensor technology has shown broad application in detecting materials. Acoustic wave sensors detect materials by generating and observing an acoustic wave. As the acoustic wave propagates through or on the surface of the material, any changes to the characteristics of the propagation path affect the velocity and/or amplitude of the wave. The amplitude, frequency, and/or phase characteristics of the sensor can be measured and correlated to a corresponding physical quantity.

Several different types of acoustic wave devices have been developed, but all have only limited success in measuring water-soluble or biological samples. Bulk acoustic waves (BAW) propagate through a medium. The most commonly used BAW devices are the thickness shear mode (TSM) resonator. The most common types are quartz crystal microbalances and the shear-horizontal acoustic plate mode (SH-APM) sensor. Conversely, waves that propagate on the surface of the substrate are known as surface waves. The most widely used surface wave devices are the surface acoustic wave sensor and the shear-horizontal surface acoustic wave (SH-SAW) sensor, also known as the surface transverse wave (STW) sensor. All acoustic wave sensors will function in gaseous or vacuum environments, but very few of them will operate efficiently, when they are in contact with liquids.

Of the known acoustic sensors for liquid sensing, the Love wave sensor, a special class of the shear-horizontal SAW, has the highest sensitivity. To make a Love wave sensor, a dielectric wave guide coating is placed on a SH-SAW device such that the energy of the shear-horizontal waves is focused in that coating. A biorecognition coating is then placed on the wave guide coating, forming the complete biosensor. Successful detection of anti-goat IgG in the concentration range of ng/ml using a 110 MHz YZ-cut SH-SAW with a polymer Love wave guide coating has been achieved [E. Gizeli et al. 1997. “Antibody Binding to a Functionalized Supported Lipid Layer: A Direct Acoustic Immunosensor,” Anal Chem, Vol. 69:4808-4813].

A comparison between different SAW sensors has recently been described [Biomolecular Sensors, Eds. Electra Gizeli and Christoffer R. Lowe (2002)]. Gizeli and Lowe describe a 124 MHz Love wave sensor having a sensitivity of 1.92 mg/cm2. The use of SAW sensors for detection of biological compounds has been reported in, for example, U.S. Pat. No. 5,478,756, WO9201931 and WO03019981, each of which being incorporated in the present application by reference in its entirety.

Conventional SAW devices are a poor choice for liquid detection, as the vertical component of the propagating wave is suppressed by the liquid-air barrier. One acoustic wave sensor that functions in liquids is a shear-horizontal SAW sensor. If the cut of the piezoelectric crystal material is rotated appropriately, waves propagate horizontally and parallel to a liquid surface. This reduces loss dramatically, when liquids come into contact with the propagating medium, allowing the SH-SAW sensor to operate as a biosensor. Many efforts at detecting liquid solution analytes, such as biological molecules, have focused on defining the interaction between the acoustic wave and the properties of the solid/liquid interface as well as on designing higher frequency SAW devices operating in the GHz range.

The present application provides a solution to the inability of SAW devices to measure analytes, including biomolecules, in liquids.

The use of SAW devices in immunoassays has been described previously. These devices consist of single crystal wafers sandwiched between two electrodes. The electrodes are provided with means for connecting these devices to an external oscillator circuit that drives the quartz crystal at its resonant frequency. This frequency is dependent on the mass of the crystal as well as the mass of any layers confined to the electrode areas of the crystal. Thus, the frequency is altered by changes in mass on the surface of the electrodes or in any layers on those electrodes. In general, the change in resonant frequency of these devices can be correlated to the amount of mass change.

U.S. Pat. No. 4,235,983 issued to Rice on 2 Dec. 1980 discloses a method for the determination of a particular subclass of antibodies. The method utilizes a piezoelectric oscillator having bound to its two-dimensional surface an antigen specific for the antibody to be determined. The antigen-coated oscillator is exposed to a solution containing an unknown amount of the antibody. After the antibody in the solution is attached to the antigen on the oscillator, the oscillator is exposed to a so-called sandwiching substance, which selectively binds to a specific subclass of the antibody being determined. The frequency of the oscillator is measured in the dry state before and after exposure to the sandwiching substance. The change in frequency is related to the amount of the subclass of the antibody bound to the two-dimensional oscillator surface. The amount of the subclass of the antibody in the solution can be determined by reference to a standard curve.

Roederer et al. disclose an in-situ immunoassay using piezoelectric quartz crystals, specifically, surface acoustic wave devices. Goat anti-human IgG was immobilized on the two-dimensional quartz crystal surface with a coupling agent. The piezoelectric crystals were then placed in an electric oscillator circuit and tested for detection of the antigen human IgG. Detection was based upon the fact that surface mass changes by adsorption are reflected as shifts in the resonant frequencies of the crystals. The authors concluded that the method suffers from both poor sensitivity and poor detection limits. The authors also concluded that the antigen to be detected must be of high molecular weight; low molecular weight analytes cannot be detected directly by this methodology [Analytical Chemistry, Vol. 55, (1983)].

Ngeh-Ngwainbi et al. describe the use of piezoelectric quartz crystals coated with antibodies against parathion which are used for the assay of parathion in the gas phase. When the coated antibody binds with parathion by a direct reaction in the gas phase, the resulting mass change on the crystal generates a frequency shift proportional to the concentration of the pesticide [J. Mat. Chem. Soc., Vol. 108, pp. 5444-5447 (1986)].

U.S. Pat. No. 4,999,284 issued to Ward on 12 Mar. 1991 discloses a method using a quartz crystal microbalance assay, in which the binding of analyte to a surface on or near a quartz crystal microbalance (QCM) is detected by a conjugate which comprises an enzyme capable of catalyzing the conversion of a substrate to a product capable of accumulating on or reacting with a two-dimensional surface of the QCM leading to a mass change and, hence, a change in resonant frequency. However, the frequency was only 406 Hz changes in 30 minutes at a concentration of 0.24 ng/ml and 6.3 Hz changes in 30 minutes at a concentration of 0.002 ng/ml (2 pg/ml) of the analyte APS reductase using an anti-APS reductase antibody. Using different modification of the two-dimensional QCM surface, the author succeeded to obtain 22 Hz changes in 30 minutes at a concentration of 0.025 ng/ml (25 pg/ml) of the analyte. This result indicates that at very low concentration (pg/ml range) the delta Hz changes is down, if not under the detection/noise level.

In general piezoelectric based immunoassays, in which mass change is attributable to the immunological reaction between an antigen and an antibody, can in circumstances, where two-dimensional sensor surfaces are used, suffer from poor sensitivity and poor detection limit. Consequently, there is a need in the art for a piezoelectric-based specific binding assay in which the reaction between a molecular recognition component and its target analyte can be amplified to provide a more sensitive assay.

### DISCLOSURE OF THE INVENTION

The inventors have surprisingly found that it is possible to detect analyte species using a combination of SAW sensor technology using a surface acoustic wave (SAW) resonator unit comprising three-dimensional structures and molecular recognition molecules.

Accordingly, in a first aspect the invention relates to a surface acoustic wave (SAW) resonator unit comprising:

(a) a piezoelectric substrate,
(b) at least one interdigital transducer electrode (IDTE) structure, and
(c) at least one reflector structure,
wherein three-dimensional micro channels are formed within the IDTE structure of (b), and wherein three-dimensional micro channels are formed within the reflector structure of (c), and in which the resonator unit further comprises a surface-immobilized molecular recognition component.

In a second aspect the invention relates to a microsensor comprising at least one surface acoustic wave (SAW) resonator unit according to the above.

In a third aspect the invention relates to a handheld device for detecting target analytes comprising the microsensor according to the above.

In a fourth aspect the invention relates to a method for detecting an analyte in a sample comprising the steps of:

(a) contacting an analyte species with an enzyme-linked second recognition component, thereby creating a complex comprising the analyte and the enzyme-linked recognition component; and
(b) contacting the complex with at least one first recognition component immobilized to a surface of a Surface Acoustic Wave (SAW) resonator unit according to the above;
(c) providing a substrate to the resonator unit of (b), where said substrate is converted to a precipitate by the linked enzyme of (a); and
(d) measuring said precipitate upon deposit on the resonator unit.

In a fifth aspect the invention relates to a method for detecting an analyte in a sample comprising the steps of:

(a) contacting an analyte species with at least one first recognition component immobilized to a surface of a Surface Acoustic Wave (SAW) resonator unit according to the above, thereby creating a complex comprising the analyte and the first recognition component;
(b) contacting the complex with an enzyme-linked second recognition component; and
(c) providing a substrate to the resonator unit, whereby said substrate is converted to a precipitate by the linked enzyme of (b); and
(d) measuring said precipitate upon deposit on the resonator unit.

In a sixth aspect the invention relates to the use of the microsensor according the above for measuring a signal upon detection of a target analyte in a sample.

The invention relates to a microsensor for detecting the presence of a target analyte in a test sample solution comprising at least one, but preferable two or more surface acoustic wave (SAW) resonator units each comprising a piezoelectric substrate, a plurality of interdigital transducer electrodes (IDTE) and reflectors on a surface of said substrate, wherein three-dimensional micro channels are formed between said electrodes and reflectors; wherein said SAW resonator unit has at least one molecular recognition component immobilized in the micro channel formed between said IDTE structures and reflector structures; reacting the target analyte in the test sample with at least one molecular recognition component; further reacting with a second enzyme-linked molecular recognition component or enzyme-linked analyte; further reacting with a substrate which is converted into a insoluble precipitate which accumulates in the micro channels formed between said electrode and reflector structures and thereby decreases the solid/liquid volume ratio in said micro channels; said solid/liquid volume ratio changes in said micro channels leading to a signal change of frequency or phase.

For the SAW resonator sensor types, stiffness changes in the bio-film in the three-dimensional micro channels between the IDTE and reflector structures also either increase or decrease the frequency of the SAW resonator unit depending on the setup. This phenomenon using hydrogel technology has been described elsewhere in US application 20060024813 by the same inventor as the present application.

The present application is directed to microsensors for detecting the presence of a target analyte in a sample solution. The microsensors include a SAW resonator sensor having three-dimensional micro channels structures on the sensor surface. The micro channel structures further include an immobilized molecular recognition component that is capable of binding the target analyte. In the micro channels the target analyte further reacts with a second enzyme-linked molecular recognition component or enzyme-linked target analyte, further reacting with a substrate which is converted into a insoluble precipitate which accumulates in the micro channels formed between said electrode and reflector structures and thereby decreases the solid/liquid volume ratio in said micro channels, said solid/liquid volume ratio changes in said micro channels leading to a signal change of frequency or phase.

The microsensor can also include reference surface acoustic wave resonator micro channel structures. In a perfect embodiment, the reference micro channels do not contain the molecular recognition component. Alternatively, the reference can be a measure of a sample solution that does not comprise the target analyte. The difference between the signal of the reference micro channels and the sensor micro channels determines the presence of the target analyte.

Non-limiting examples of molecular recognition components include nucleic acids, nucleotides, nucleosides, nucleic acid analogues such as PNA and LNA molecules, proteins, peptides, antibodies including IgA, IgG, IgM, IgE, enzymes, enzymes cofactors, enzyme substrates, enzymes inhibitors, receptors, ligands, kinases, Protein A, Poly U, Poly A, Poly lysine, triazine dye, boronic acid, thiol, heparin, polysaccharides, coomassie blue, azure A, metal-binding peptides, sugar, carbohydrate, chelating agents, prokaryotic cells and eukaryotic cells.

Non-limiting examples of target analytes include nucleic acids, proteins, peptides, antibodies, enzymes, carbohydrates, chemical compounds, and gasses. Other exemplary target analytes include Troponin 1, Troponin T, allergens, or immunoglobulins such as IgE. In certain applications, the target analyte is capable of binding more than one molecular recognition component.

The present application is also directed to methods for detecting a target analyte in a sample solution. A molecular recognition component is immobilized in the micro channels located on a surface of a surface acoustic wave sensor. The sensor is contacted with the sample under conditions promoting binding of the analyte in the sample to the recognition component. A change in phase shift or frequency of a surface acoustic wave is then detected. The change determines the presence of the analyte in the sample.

It has been observed that the amplitude of the SAW resonator unit should be adjusted for optimal conditions for at least one molecular recognition component to react with the target analyte in the test sample. If the amplitude is too high, inconsistent results can be obtained due to non-optimal conditions for molecular recognition component/analyte interaction.

A method for detecting an analyte in a test sample comprising the following steps: reacting the analyte in a test sample with a first recognition component and a second enzyme-linked recognition component of enzyme-linked analyte; adding a substrate which is converted into a insoluble precipitate by said linked enzyme; wherein the two steps are executed in a reaction vessel segregate from the SAW resonator units and wherein said insoluble precipitate obtained is actively transported to said SAW resonator units, where it upon contact with the SAW micro channels formed between said electrode and reflector structures decreases the solid/liquid volume ratio in said micro channels; said solid/liquid volume ratio changes in said micro channels leading to a signal change of frequency or phase; said signal change elicits an analyte specific signal.

A target analyte can be detected in any sample. Exemplary samples include blood, serum, plasma, ascites, faeces, spinal core fluids, urine, smears and saliva. The method can be used for diagnostic purposes.

### BRIEF DESCRIPTION OF THE DRAWINGS

The invention is explained in detail below with reference to the drawings, in which

FIG. 1 illustrates two SAW resonator units indicated generally by the reference numerals 1 and 2. Each SAW resonator units consists of one IDTE part (7, 8) and two reflector parts (9, 10). The micro channels (4, 5) are located between the IDTE (3, 6). Identical micro channels are also located between the reflector structures (15, 16). On the entire SAW resonator unit (1) three-dimensional surfaces, molecular recognition components are immobilized (3, 17), whereas on SAW resonator unit (2), no molecular recognition component is present. The reaction layer (11) represents the analyte and second enzyme-linked molecular recognition component and substrate. When the substrate converts to insoluble precipitates, the micro channels space (16) between reflector structures (12, 13) decreases due to solid/liquid volume ratio changes in the micro channels (16). Also, the micro channels between IDTE in SAW resonator unit (1) decrease for the same reasons. No micro channels (15) solid/liquid volume ratio changes are seen between the structures (14, 18) on the SAW resonator units (2).

FIG. 2 illustrates two SAW resonator units (1, 2) on the same substrate, otherwise identical to FIG. 1.

FIG. 3 illustrates a dose response curve further described under EXAMPLE 1.

FIG. 4 illustrates an AFM picture of the reflector structures illustrated in FIG. 1 (9). Number 1 represents the substrate. Number 2 represents the reflector structures. Numbers 3 and 4 represent the dimension of the micro channel between the reflector structures.

FIG. 5 illustrates a calculation scheme from the AFM picture shown in FIG. 4. Here are some examples of the dimensions of the IDTE and the reflector structures.

### DETAILED DESCRIPTION OF THE INVENTION

### Definitions

“Binding event” as used in this application means the binding of the target analyte to the molecular recognition component immobilized in the three-dimensional micro channel structure surface of the SAW sensor.

The invention may be understood by reference to the drawings, where like reference numerals are used to indicate like elements.

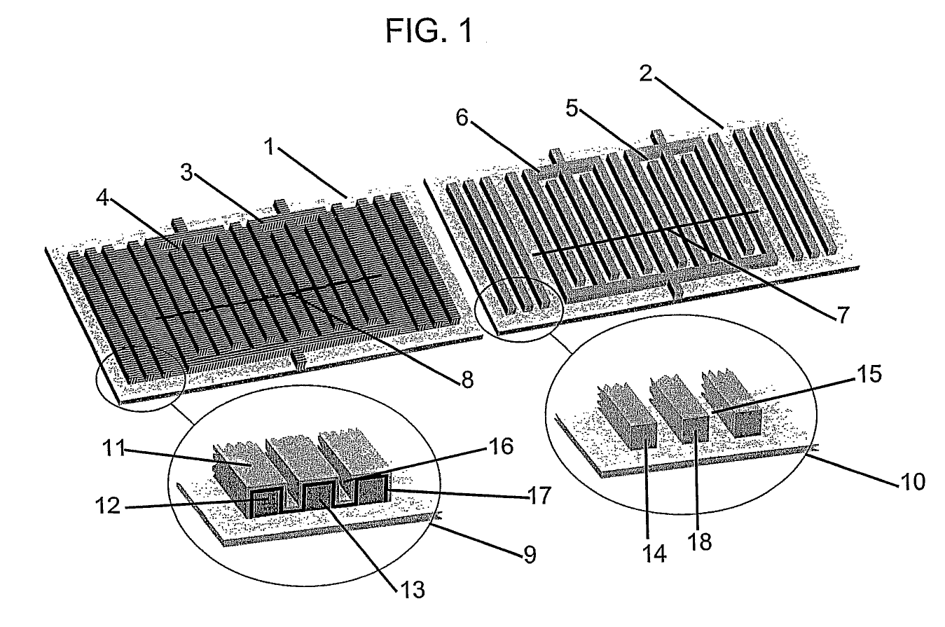

Referring to FIG. 1, there is shown a microsensor consisting of two SAW resonator units indicated generally by the reference numerals 1 and 2. Each SAW resonator unit consists of one IDTE part (7, 8) and two reflector parts (9, 10). The micro channels (4, 5) are located between the IDTE (3, 6). Identical micro channels are also located between the reflector structures (15, 16). On the entire SAW resonator unit (1) three-dimensional surfaces, molecular recognition components are immobilized (3, 17), whereas on SAW resonator unit (2), no molecular recognition component is present. The reaction layer (11) represents the analyte and second enzyme-linked molecular recognition component and substrate. When the substrate converts to insoluble precipitates, the micro channels space (16) between reflector structures (12, 13) decreases due to solid/liquid volume ratio changes in the micro channels (16). Also, the micro channels between IDTE in SAW resonator unit (1) decrease for the same reasons. No micro channels (15) solid/liquid volume ratio changes are seen between the structures (14, 18) on the SAW resonator units (2).

Examples of enzyme/substrate systems which are capable of producing an insoluble product which is capable of accumulating in the micro channels (16) include alkaline phosphatase and 5-bromo-4-chloro-3-indolylphosphate (BCIP). The enzymatically catalyzed hydrolysis of BCIP produces an insoluble dimer, which precipitates in the micro channels. Other analogous substrates having the phosphate moiety replaced with such hydrolytically cleavable functionalities as galactose, glucose, fatty acids, fatty acid esters and amino acids can be used with their complementary enzymes.

Other enzyme/substrate systems include peroxidase enzymes, for example horse radish peroxidase (HRP) or myeloperoxidase, and one of the following: benzidene, benzidene dihydrochloride, diaminobenzidene, o-tolidene, o-dianisidine and tetramethyl-benzidene, carbazoles, particularly 3-amino-9-ethylcarbazole, all of which have been reported to form precipitates upon reaction with peroxidases. Also, oxidases such as alphahydroxy acid oxidase, aldehyde oxidase, glucose oxidase, L-amino acid oxidase and xanthine oxidase can be used with oxidizable substrate systems such as a phenazine methosulfate-nitriblue tetrazolium mixture.

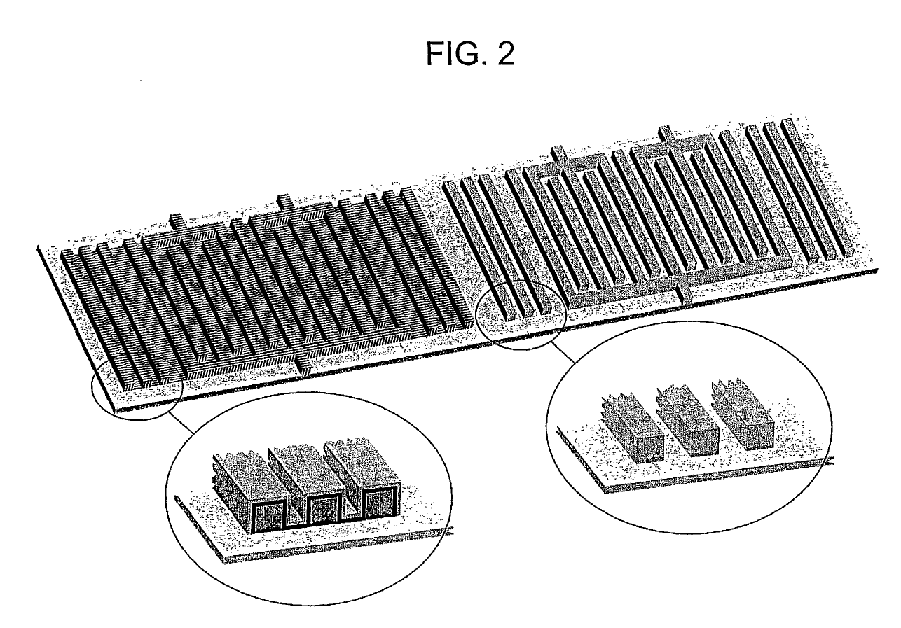

Referring to FIG. 2, this FIG. 2 shows two SAW resonator units (1,2) on the same substrate, otherwise identical to FIG. 1.

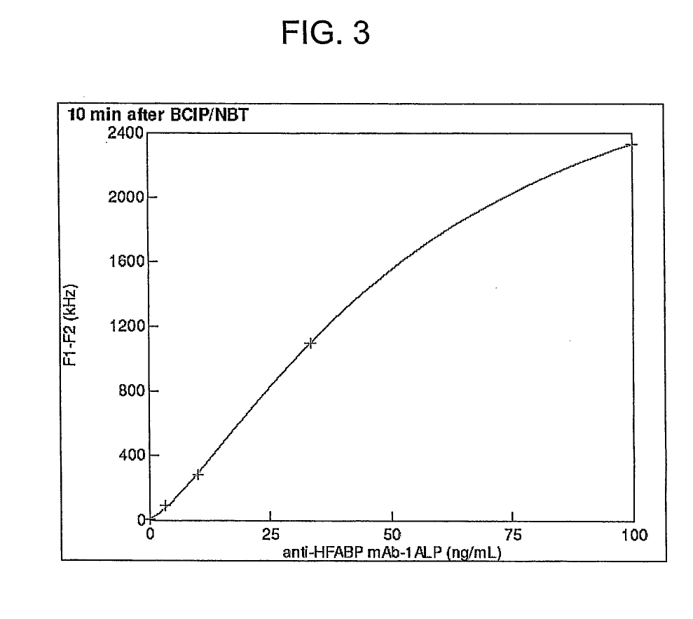

Referring to FIG. 3, this FIG. 3 is further described under EXAMPLE 1.

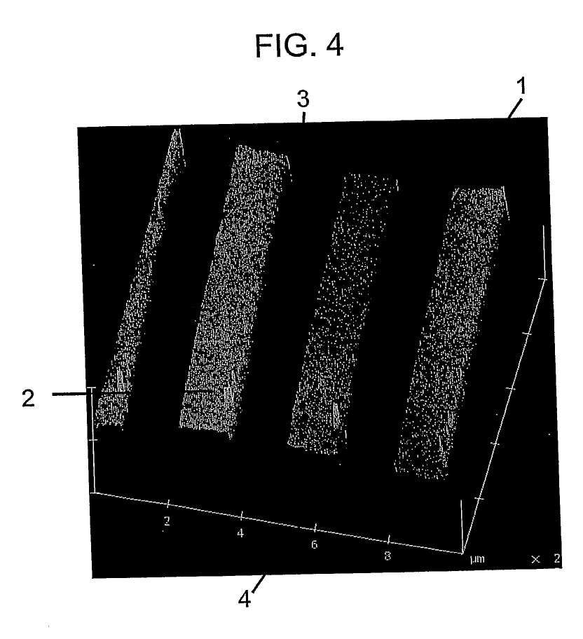

FIG. 4 depicts an AFM picture of the reflector structures illustrated in FIG. 1 (9). Number 1 represents the substrate. Number 2 represents the reflector structures. Numbers 3 and 4 represent the dimension of the micro channel between the reflector structures.

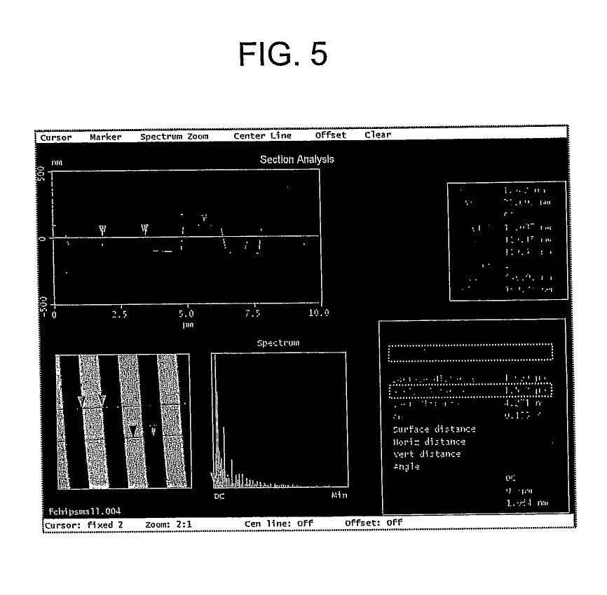

FIG. 5 depicts a calculation scheme from the AFM picture shown in FIG. 4. Here are some examples of dimensions of the reflector and IDTE structures.

### Surface Acoustic Wave Sensors

The microsensors disclosed in this application include at least one surface acoustic wave sensor. A surface acoustic wave sensor includes a piezoelectric layer, or piezoelectric substrate, and input and output transducer. A surface acoustic wave is generated within the piezoelectric layer and is detected by interdigitated electrodes. As described in more detail below, binding events that alter the surface of the surface acoustic wave sensor can be detected as a change in a property of the propagating surface acoustic wave. Surface acoustic wave sensors are described in U.S. Pat. Nos. 5,130,257, 5,283,037 and 5,306,644; F. Josse, et. al. “Guided Shear Horizontal Surface Acoustic Wave Sensors for Chemical and Biochemical Detection in Liquids,” Anal. Chem. 2001, 73, 5937; and W. Welsch, et. al., “Development of a Surface Acoustic Wave Immunosensor,”Anal. Chem. 1996, 68, 2000-2004, each of which hereby expressly being incorporated in its entirety by reference.

Acoustic wave devices are described by the mode of wave propagation through or on a piezoelectric substrate. Acoustic waves are distinguished primarily by their velocities and displacement directions. Many combinations are possible, depending on the material and boundary conditions. The interdigital transducer electrode (IDTE) of each sensor provides the electric field necessary to displace the substrate and thus form an acoustic wave. The wave propagates through the substrate, where it is converted back to an electric field at the IDTE at the opposing electrode. Transverse or shear waves have particle displacements that are normal to the direction of wave propagation and which can be polarized so that the particle displacements are either parallel to or normal to the sensing surface. Shear-horizontal wave motion signifies transverse displacements polarized parallel to the sensing surface; shear-vertical motion indicates transverse displacements normal to the surface.

“Surface acoustic wave sensor” or “surface acoustic wave device” as used in this application mean any device that operates substantially in the manner described above. In some embodiments, “surface acoustic wave sensor” refers to both surface transverse wave devices, where the surface displacement is perpendicular to the direction of propagation and parallel to the device surface, as well as to surface acoustic wave sensors, where at least a portion of the surface displacement is perpendicular to the device surface. While surface transverse wave devices generally have better sensitivity in a fluid, it has been shown that sufficient sensitivity may also be achieved, when a portion of the surface displacement is perpendicular to the device surface. See, for example, M. Rapp, et al. “Modification of Commercially Available LOW-LOSS SAW devices towards an immunosensor for in situ Measurements in Water” 1995 IEEE International Ultrasonics Symposium, Nov. 7-10, 1995, Seattle, Wash.; and N. Barie, et al., “Covalent bound sensing layers on surface acoustic wave biosensors,” Biosensors & Bioelectronics 16 (2001) 979, all of which being expressly incorporated herein by reference.

The sensors are made by a photolithographic process. Manufacturing begins by carefully polishing and cleaning the piezoelectric substrate. Metal, such as gold or aluminum, is then deposited uniformly onto the substrate. The device is spin-coated with a photoresist and baked to harden it. It is then exposed to UV light through a mask with opaque areas corresponding to the areas to be metalized on the final device. The exposed areas undergo a chemical change that allows them to be removed with a developing solution. Finally, the remaining photoresist is removed. The pattern of metal remaining on the device is called an interdigital transducer (IDT) or interdigital electrode (IDE). By changing the length, width; position and thickness of the IDT, the performance of the sensor can be maximized.

Molecular recognition of a sample comprising a significant background signal often requires amplification of the signal. The inventors found that it was possible to apply a known molecular method, wherein a second recognition component comprising an amplification element such as a linked enzyme is included, to the resonation unit and the method according to the invention. The SAW sensor responded very efficiently to the mass increase of the sensor surface in precipitation of substrate cleaved by the enzyme. Accordingly, in a preferred aspect the resonator unit further comprises a secondary molecular recognition component after binding to the analyte. This secondary molecular recognition component is preferably an enzyme-linked antibody. The linked enzyme is preferably an alkaline phosphatase (ALP) or horse radish peroxidase (HRP).

In order to obtain the best results in terms of altered signal upon binding between analyte and molecular recognition element, the resonator unit should contain at least two adjacent IDTEs having a height from 10 nm to 1 micron and where the micro channel between said adjacent IDTEs has a width from 100 nm to 10 microns.

In order to obtain the best results in terms of altered signal upon binding between analyte and molecular recognition element, the resonator unit should contain at least two adjacent reflectors having a height from 10 nm to 1 micron and where the micro channel between said adjacent reflectors has a width from 100 nm to 10 microns.

In order to obtain the best results in terms of altered signal upon binding between analyte and molecular recognition element the resonator unit should contain at least two adjacent IDTE/reflectors junctions having a height from 10 nm to 1 micron and where the micro channel between said adjacent structures has a width from 100 nm to 10 microns.

The molecular recognition component is preferably selected from the group consisting of nucleic acids, nucleotide, nucleoside, nucleic acids analogues such as PNA and LNA molecules, proteins, peptides, antibodies including IgA, IgG, IgM, IgE, enzymes, enzymes cofactors, enzyme substrates, enzymes inhibitors, receptors, ligands, kinases, Protein A, Poly U, Poly A, Poly lysine, triazine dye, boronic acid, thiol, heparin, polysaccharides, coomassie blue, azure A, metal-binding peptides, sugar, carbohydrate, chelating agents, prokaryotic cells and eukaryotic cells.

Preferably, the resonator unit has at least one extra insulation coating. Such extra insulation coating may consist of e.g. titanium, SiO2, a dielectric thin film, quartz or any kind of polymer material having an extra coating consisting of but not limited to gold (Au), silver (Ag), SiO₂, aluminium (Al) or any kind of polymer material.

The piezoelectric substrate is preferably selected from the group containing quartz (SiO.sub.2), lithium tantalate (LiTaO.sub.3) and, to a lesser degree, lithium niobate (LiNbO.sub.3). Other materials with commercial potential include gallium arsenide (GaAs), silicon carbide (SiC), langasite (LGS), zinc oxide (ZnO), aluminum nitride (AlN), lead zirconium titanate (PZT) and polyvinylidene fluoride (PVdF). The piezoelectric substrate may be made from quartz, lithium niobate (LiNbO.sub.3) or any other piezoelectric material.

The molecular recognition component is selected from the group consisting of nucleic acids, nucleotide, nucleoside, nucleic acids analogues such as PNA and LNA molecules, proteins, peptides, antibodies including IgA, IgG, IgM, IgE, enzymes, enzymes cofactors, enzyme substrates, enzymes inhibitors, receptors, ligands, kinases, Protein A, Poly U, Poly A, Poly lysine, triazine dye, boronic acid, thiol, heparin, polysaccharides, coomassie blue, azure A, metal-binding peptides, sugar, carbohydrate, chelating agents, prokaryotic cells and eukaryotic cells.

Preferably, the analyte species is derived from a fluid mammal sample selected from the group consisting of blood, serum, plasma, faeces, spinal core fluids and urine.

The resonator units according to the invention may be used in a microsensor suitable for detecting an analyte species from a sample.

Preferably, the microsensor comprises at least one set of surface acoustic wave (SAW) resonator units according to the invention.

In one embodiment of the invention the units of a set are placed on the same piezoelectric substrate.

In one embodiment of the invention the units of a set are placed on separate piezoelectric substrates.

In order to achieve a signal that can be used to calculate the amount of analyte, the signal must be compared to a reference (background) signal. Thus, in a preferred embodiment the microsensor further comprises at least one reference surface acoustic wave (SAW) resonator unit that does not comprise immobilized molecular recognition components. Preferably, the microsensor comprises at least one set of surface acoustic wave (SAW) resonator units that do not comprise immobilized molecular recognition components.

SAW sensors are small sensors making the technology suitable for use in handheld devices. Accordingly, the invention further relates to a handheld device for detecting target analytes comprising the microsensor according to the above.

In another aspect the invention relates to a method for detecting an analyte in a sample comprising the steps of:

(a) contacting an analyte species with at least one first recognition component immobilized to a surface of a Surface Acoustic Wave (SAW) resonator unit according to any of claims 1-9, thereby creating a complex comprising the analyte and the first recognition component, and
(b) measuring the mass increase upon binding of the analyte on the resonator unit.

In another aspect the invention relates to a method for detecting an analyte in a sample comprising the steps of:

(a) contacting an analyte species with an enzyme-linked second recognition component, thereby creating a complex comprising the analyte and an enzyme-linked recognition component; and
(b) contacting the complex with at least one first recognition component immobilized to a surface of a Surface Acoustic Wave (SAW) resonator unit according to the invention;
(c) providing a substrate to the resonator unit of (b), where said substrate is converted to a precipitate by the linked enzyme of (a); and
(d) measuring said precipitate upon deposit on the resonator unit.

In another aspect the invention relates to a method for detecting an analyte in a sample comprising the steps of:

(a) contacting an analyte species at least one first recognition component immobilized to a surface of a Surface Acoustic Wave (SAW) resonator unit according to the invention, thereby creating a complex comprising the analyte and the first recognition component;
(b) contacting the complex with an enzyme-linked second recognition component; and
(c) providing a substrate to the resonator unit, whereby said substrate is converted to a precipitate by the linked enzyme of (b); and
(d) measuring said precipitate upon deposit on the resonator unit.

In another aspect the invention relates to the use of the microsensor according to the above for measuring a signal upon detection of a target analyte in a sample.

Preferably, the analyte is selected from the group consisting of Troponin I, Troponin T, BNP, an H-FABP, an allergen and IgE.

### Input and Output Transducer(s)

The input and output transducers are preferably interdigitated transducers. Generally, there are two interdigital transducers. Each of the input and output transducers comprises two electrodes arranged in an interdigitated pattern. A voltage difference applied between the two electrodes of the input transducer results in the generation of a surface acoustic wave in the piezoelectric substrate. The electrodes generally may comprise any conductive material, with aluminium or gold being preferred.

The electrode(s) may take any conventional form, but are preferably photolithographically deposited on the surface as elongate regions of metallisation transverse to the direction of propagation of a wave along the surface of the support. The elongate metallized regions preferably have a width and spacing of the same order of magnitude. The width is typically between 1 and 40 microns, preferably between 10 and 20 microns. In certain embodiments, the width is greater than or equal to 100 nm, 200 nm, 300 nm, 400 nm, 500 nm, 600 nm, 700 nm, 800 nm, 900 nm, 1 micron, 2 microns, 3 microns, 4 microns, 5 microns, 7.5 microns, 10 microns, 15 microns, 20 microns, 25 microns, 30 microns, 35 microns, 40 microns, 45 microns, 50 microns, 60 microns, 70 microns, 80 microns or 90 microns. In other embodiments, the space between the electrodes can be equal to or less than 100 microns, 90 microns, 80 microns, 70 microns, 60 microns, 50 microns, 45 microns, 40 microns, 35 microns, 30 microns, 25 microns, 20 microns, 15 microns, 10 microns, 7.5 microns, 5 microns, 4 microns, 3 microns, 2 microns 1 microns, 900 nm, 800 nm, 700 nm, 600 nm, 500 nm, 400 nm, 300 nm, 200 nm, 100 nm, or 75 nm. It should be noted that the spacing varies inversely with the frequency of the device.

In certain embodiments, the height of the electrodes is the same as the width of the electrodes. In other embodiments, the height of the electrodes is, for example, greater than or equal to 10 nm, 20 nm, 30 nm, 40 nm, 50 nm, 75 nm, 100 nm, 200 nm, 300 nm, 400 nm, 500 nm, 600 nm, 700 nm, 800 nm, or 900 nm. In other embodiments, the depth of the space between the electrodes can be less than or equal to 1 micron, 900 nm, 800 nm, 700 nm, 600 nm, 500 nm, 400 nm, 300 nm, 200 nm, 100 nm, 75 nm, 50 nm, 40 nm, 30 nm, or 20 nm.

In an alternative embodiment there is a single interdigital transducer. In this embodiment the single interdigital transducer serves both as input and output transducer. In embodiments employing a single interdigital transducer acting as both input and output transducer, a reflector structure is generally provided to generate one or more resonances within the SAW sensor. The reflector structure may, for example, be a thin film grating. The grating may comprise aluminium or another conductive material. The generated resonances can be detected, for example, by measuring the power dissipated at the single transducer. One or more binding events in the thin structure alter these resonances, allowing the binding events to be detected. An example of a sensor and technique according to this embodiment is generally described in U.S. Pat. No. 5,846,708, hereby incorporated by reference. As described below, other electronics and/or circuitry may similarly be utilized in an embodiment employing a SAW sensor having only one interdigital transducer.

Molecular recognition molecules may be attached directly to self-assembled monolayers. For example, when gold IDTE's are employed, a DNA probe molecule may be attached using a SH group on the 5′ of the DNA using self-assembled monolayers as known in the art and described, for example, in K. Vijayamohanan et al. “Self-assembled monolayers as a tunable platform for biosensor applications,” Biosensors & Bioelectronics 17 (2002) 1-12 and George M. Whitesides et al. “Array of Self-Assembled Monolayers for studing inhibition of Bacterial Adhesion.” Anal Chem 2002, 74, 1805-1810, both of which hereby being incorporated by reference.

The present invention further relates to (1) a method for detecting an analyte in a sample comprising the following steps:

(a) reacting the analyte in a sample with a first recognition component and a second enzyme-linked recognition component;
(b) adding a substrate, which is converted into a precipitate by said linked enzyme;
(c) wherein steps (a) and (b) are executed in a reaction vessel segregate from the measuring chamber and wherein said precipitate obtained in step (b) is actively trans-ported to said measuring chamber, where it upon contact with the SAW sensor surface elicits an analyte specific signal.

Further embodiments of the present invention are:

(2) The method as the above (1) and/or as in one of the succeeding embodiments, wherein the first recognition component immobilizes the analyte to a surface in the reaction vessel.
(3) The method as the above (1) and/or as in one of the succeeding embodiments, wherein the surface may be the reaction vessel lining or the surface of material contained in the vessel cavity or a combination thereof.
(4) The method as the above (1) and/or as in one of the succeeding embodiments, wherein the recognition components are selected from the group containing protein, protein analogues, modified proteins, nucleic acid, nucleic acid analogues and modified nucleic acids.
(5) The method as the above (1) and/or as in one of the succeeding embodiments, wherein the protein is selected from the group containing antibody, antibody fragments, modified antibodies, receptor molecules and ligand molecules.
(6) The method as the above (1) and/or as in one of the succeeding embodiments, wherein the enzyme is selected from the group containing alkaline phosphatase (AP) and horse radish peroxidase (HRP).
(7) The method as the above (1) and/or as in one of the succeeding embodiments, wherein the substrate is selected from the group containing diaminobenzidine (DAP), amino ethylcarbazole (AEC), tetramethylbenzidine (TMB) or 5-bromo,4-chloro,3-indolylphosphate (BCIP)/nitroblue tetrazolium (NBT).

The present invention furthermore relates to (8) a device for detecting an analyte in a sample according to the method as the above (1) and/or as in one of the succeeding embodiments, comprising:

(a) a reaction vessel with an inlet and an outlet in which the analyte specific precipitate is generated by enzyme conversion; connected to
(b) a measuring chamber with an inlet and an outlet comprising a SAW sensor;
(c) wherein a liquid flow is actively transporting said precipitate from the reaction vessel to the measuring chamber, where it comes into contact with the SAW sensor surface and elicits an analyte specific signal.

Further embodiments of the present invention are:

(9) The device as the above (8) and/or as in one of the succeeding embodiments, further connected to a flow regulator, wherein said regulator is a pump system placed in front of the reaction vessel, a suction system placed after the measuring chamber or both.
(10) The device as the above (8) and/or as in one of the succeeding embodiments, wherein the reaction vessel is selected from the group containing a tube, a tubing system, a chamber and a system of connected chambers.
(11) The device as the above (8) and/or as in one of the succeeding embodiments, further comprising material retained within the reaction vessel system selected from the group containing beads and gel.
(12) The device as the above (8) and/or as in one of the succeeding embodiments, wherein the reaction vessel system further comprises one or more material selected from the group comprising filter and grid.
(13) The device as the above (8) and/or as in one of the succeeding embodiments, wherein the SAW sensor is of SAW filter unit type.

### EXAMPLES

The following non-limiting examples serve to describe more fully the manner of using the above described invention. It is understood that these examples in no way serve to limit the scope of this invention, but rather are presented for illustrative purposes.

### Example 1

### Assay of Anti-Mouse IgG/Anti-HFABP mAb-ALP

The procedure was performed according to the mode illustrated in FIG. 1. A microsensor consisting of two SAW resonator units (FIG. 1.-1, 2) was used. A SAW resonator unit with three-dimensional surfaces (FIG. 1.-1) was coated with 20 nm of gold. An identical SAW resonator unit with three-dimensional surfaces (FIG. 1.-2) was coated with SIO2. The gold surfaces of SAW resonator in FIG. 1.-1 were incubated with 100 ug/ml goat anti-mouse IgG, while the SIO2 surface of SAW resonator in FIG. 1.-2 was incubated with 100 ug/ml goat IgG.

The first step was adsorption of the anti-mouse antibody on the gold-coated three-dimensional SAW surface. This was performed by equilibration of the gold/SAW resonator unit with 2 uL of 100 ug/mL antibody in PBS buffer solution for 2 hours in a humid environment. Both SAW resonator units were then washed three times with PBS buffer containing 0.05% tween. After this treatment, the two SAW resonator units (FIG. 1-1, 2) were incubated with 1% BSA in PBS for 1 hour at room temperature in a humid environment. Both SAW resonator units were then washed three times with TBS buffer/0.05% tween. The two SAW resonators units (FIG. 1-1, 2) were then exposed to varied concentrations of the mouse antibody (anti-HFABP mAb-ALP) label with an alkaline phosphatase enzyme (ALP) in PBS buffer for 15 minutes. After being washed three times with TBS/0.05% tween, BCIP/NBT (SIGMA) was added and the delta frequency between SAW resonator (FIG. 1-1) and SAW resonator unit (FIG. 2-2) was measured after 10 minutes (experiments I-VII).

Control (Experiment VIII)—Goat IgG was Incubated on Both SAW Resonator Units (FIG. 1-1,2)

The two SAW resonators units (FIG. 1-1, 2) were then exposed to 100 ng/ml of the mouse antibody (anti-HFABP mAb-ALP) label with an alkaline phosphatase enzyme (ALP) in PBS buffer for 15 minutes. After being washed three times with TBS/0.05% tween, BCIP/NBT (SIGMA) was added and the delta frequency between SAW resonator (FIG. 1-1) and SAW resonator unit (FIG. 2-2) was measured after 10 minutes (experiment VIII).

TABLE I

| | | SAW resonator | |
|---|---|---|---|
| | anti-HFABP mAb- | unit (2)-(1) after | |
| Experiment No. | ALP (ng/ml) | 10 min. (kHz) | CV (%) |
| I | 100 | −2100 | — |
| II | 100 | −2500 | — |
| III | 100 | −2400 | — |
| Mean | 100 | −2333 | 9 |
| IV | 33.3 | −1100 | — |
| V | 10 | −350 | — |
| VI | 10 | −325 | — |
| VII | 10 | −175 | — |
| Mean | 10 | −283 | 33 |
| VIII (control) | control goat IgG | −1 | — |

Using the data from table I, a dose-response curve was generated, which is illustrated in FIG. 3. The R value=1.00

### Example 2

### Assay of Anti-Mouse IgG/Anti-HFABP mAb-2ALP

Same assay procedure as in Example I, however, to further enhance the sensitivity an anti-mouse IgG/anti-HFABP mAb-2ALP was used as analyte (labelled with 2 ALP enzymes pr. Antibody).

TABLE II

| | | SAW resonator | |
|---|---|---|---|
| | anti-HFABP mAb- | unit (2)-(1) after | |
| Experiment No. | ALP (ng/ml) | 10 min. (kHz) | CV (%) |
| I | 1 | −294 | — |
| II | 1 | −310 | — |
| III | 1 | −317 | — |

1. A surface acoustic wave (SAW) resonator unit comprising:
(a) a piezoelectric substrate,
(b) at least one interdigital transducer electrode (IDTE) structure, and
(c) at least one reflector structure,
wherein three-dimensional micro channels are formed within the IDTE structure of (b), and wherein three-dimensional micro channels are formed within the reflector structure of (c), and in which the resonator unit further comprises a surface-immobilized molecular recognition component.

2. The resonator unit according to claim 1, wherein said immobilized molecular recognition component is further bound to a target species comprising an analyte species and a secondary molecular recognition component.

3. The resonator unit according to claim 2, wherein said secondary molecular recognition component is an enzyme-linked antibody.

4. The resonator unit according to claim 1, wherein at least two adjacent IDTEs have a height from 10 nm to 1 micron and the micro channel between said adjacent electrodes has a width from 100 nm to 10 microns.

5. The resonator unit according to claim 1, wherein at least two adjacent reflectors have a height from 10 nm to 1 micron and the micro channel between said adjacent electrodes has a width from 100 nm to 10 microns.

6. The resonator unit according to claim 1, wherein at least two adjacent IDTE/reflectors junctions have a height from 10 nm to 1 micron and the micro channel between said adjacent structures has a width from 100 nm to 10 microns.

7. The resonator unit according to claim 1, wherein the substrate is selected from the group containing diaminobenzidine (DAP), amino ethylcarbazole (AEC), Tetramethylbenzidine (TMB) or 5-bromo,4-chloro,3-indolylphosphate (BCIP)/nitroblue tetrazolium (NBT).

8. The resonator unit according to claim 1, having at least one extra insulation coating.

9. The resonator unit according to claim 1, wherein the analyte species is derived from a fluid mammal sample selected from the group consisting of blood, serum, plasma, faeces, spinal core fluids and urine.

10. A microsensor comprising at least one surface acoustic wave (SAW) resonator unit according to claim 1.

11. (canceled)

12. The microsensor according to claim 10, further comprising at least one reference surface acoustic wave (SAW) resonator unit that does not comprise immobilized molecular recognition components.

13. The microsensor according to claim 12, comprising at least one set of reference surface acoustic wave (SAW) resonator units that do not comprise immobilized molecular recognition components.

14. A handheld device for detecting target analytes comprising the microsensor of claim 10.

15. A method for detecting an analyte in a sample comprising the steps of:
(a) contacting an analyte species with at least one first recognition component immobilized to a surface of a Surface Acoustic Wave (SAW) resonator unit according to claim 1, thereby creating a complex comprising the analyte and the first recognition component, and
(b) measuring the mass increase upon binding of the analyte on the resonator unit.

16. A method for detecting an analyte in a sample comprising the steps of:
(a) contacting an analyte species with at least one first recognition component immobilized to a surface of a Surface Acoustic Wave (SAW) resonator unit according to claim 1, thereby creating a complex comprising the analyte and the first recognition component;
(b) contacting the complex with an enzyme-linked second recognition component;
(c) providing a substrate to the resonator unit, whereby said substrate is converted to a precipitate by the linked enzyme of (b); and
(d) measuring said precipitate upon deposit on the resonator unit.

17. The method according to claim 15, wherein the analyte is selected from the group consisting of Troponin I, Troponin T, BNP, an H-FABP, an allergen and IgE.

18. Use of the microsensor according to claim 10, for measuring a signal upon detection of a target analyte in a sample.

19. Use of the microsensor according to claim 14, wherein the target analyte is selected from the group consisting of Troponin I, Troponin T, BNP, an H-FABP, an allergen and IgE.
